(19) United States
(12) Patent Application Publication
(10) Pub. No.: US 2014/0140094 A1
(43) Pub. Date: May 22, 2014

(54) LIGHT SOURCE DEVICE, DISPLAY UNIT, AND ELECTRONIC APPARATUS

(71) Applicant: Sony Corporation, Tokyo (JP)

(72) Inventor: Ryo Miyao, Tokyo (JP)

(73) Assignee: Sony Corporation, Tokyo (JP)

(21) Appl. No.: 14/079,822

(22) Filed: Nov. 14, 2013

(30) Foreign Application Priority Data
Nov. 21, 2012 (JP) 2012-255659

(51) Int. Cl. F21V 8/00

(52) U.S. Cl. CPC G02B 6/0013
USPC 362/609; 362/613

(57) ABSTRACT

A display unit includes a display section, and a light source device. The light source device includes: one or a plurality of first light sources each configured to emit first illumination light; and a light guide plate having a first end surface, a second end surface, and a plurality of scattering regions, and scattering the first illumination light in the scattering regions to emit the light to outside, the first end surface and the second end surface being opposed to each other, and the scattering regions being provided with a constant density and a uniform shape in a predetermined region between the first and second end surfaces. The first light sources are arranged to face at least the first end surface, and an inclined section guiding the first illumination light to the predetermined region is provided between the first light sources and the predetermined region of the light guide plate.

### CROSS REFERENCES TO RELATED APPLICATIONS

The present application claims priority to Japanese Priority Patent Application JP 2012-255659 filed in the Japan Patent Office on Nov. 21, 2012, the entire content of which is hereby incorporated by reference.

### BACKGROUND

The present disclosure relates to a light source device, a display unit, and an electronic apparatus that enable stereoscopic viewing and multiple viewing in a parallax barrier system.

A stereoscopic display unit of parallax barrier system is known as one of stereoscopic display systems capable of providing stereoscopic viewing with naked eyes without special glasses. The stereoscopic display unit has a parallax barrier that is disposed so as to face a front surface (display surface side) of a two-dimensional display panel. A typical configuration of the parallax barrier includes shielding sections and stripe-shaped openings (slits) that are alternately arranged in a horizontal direction. The shielding section shields display image light from the two-dimensional display panel, and the stripe-shaped opening allows the display image light to pass therethrough.

In the parallax barrier system, parallax images for stereoscopic viewing (a perspective image for right eye and a perspective image for left eye in the case of two perspectives) are displayed, in a space-divisional manner, on the two-dimensional display panel, and the parallax images are separated in the horizontal direction by the parallax barrier, thereby achieving stereoscopic viewing. It is possible to allow light of different perspective images to separately enter right and left eyes of a viewer through the slits by appropriately setting a width of each of the slits of the parallax barrier and the like when the viewer views the stereoscopic display unit from a predetermined position in a predetermined direction.

Note that, in the case where a transmissive liquid crystal display panel is used as the two-dimensional display panel, for example, it is possible to dispose a parallax barrier on a back surface side of the two-dimensional display panel. In this case, the parallax barrier is disposed between the transmissive liquid crystal display panel and a backlight. In Japanese Unexamined Patent Application Publication No. 2012-226294, there is disclosed a light source device in which a scattering pattern is provided on an internal reflection surface of a light guide plate serving as a backlight and thus the light guide plate has a function equivalent to a parallax barrier.

### SUMMARY

As described in Japanese Unexamined Patent Application Publication No. 2012-226294, in the case of the configuration in which the light guide plate has a function equivalent to a parallax barrier, in-plane luminance distribution of light emitted from the light guide plate may be preferably uniform. In Japanese Unexamined Patent Application Publication No. 2012-226294, the shape of the scattering pattern is modified depending on positions, and thus in-plane luminance distribution is allowed to be uniform. On the other hand, even in the case where a scattering pattern having a uniform shape is provided, uniform in-plane luminance distribution is desired.

Accordingly, it is desirable to provide a light source device, a display unit, and an electronic apparatus that achieve a function equivalent to a parallax barrier with use of a light guide plate, and improve non-uniformity of in-plane luminance distribution.

According to an embodiment of the technology, there is provided a light source device including: one or a plurality of first light sources each configured to emit first illumination light; and a light guide plate having a first end surface, a second end surface, and a plurality of scattering regions, and scattering the first illumination light in the plurality of scattering regions to emit light for displaying a plurality of perspective images to outside, the first end surface and the second end surface being opposed to each other, and the plurality of scattering regions being provided with a constant density and a uniform shape in a predetermined region between the first end surface and the second end surface. The one or the plurality of first light sources are arranged to face at least the first end surface, and an inclined section guiding the first illumination light to the predetermined region is provided between the one or the plurality of first light sources and the predetermined region of the light guide plate.

According to an embodiment of the technology, there is provided a display unit including a display section configured to display a plurality of perspective images, and a light source device configured to emit light for displaying the plurality of perspective images toward the display section. The light source device includes: one or a plurality of first light sources each configured to emit first illumination light; and a light guide plate having a first end surface, a second end surface, and a plurality of scattering regions, and scattering the first illumination light in the plurality of scattering regions to emit the light to outside, the first end surface and the second end surface being opposed to each other, and the plurality of scattering regions being provided with a constant density and a uniform shape in a predetermined region between the first end surface and the second end surface. The one or the plurality of first light sources are arranged to face at least the first end surface, and an inclined section guiding the first illumination light to the predetermined region is provided between the one or the plurality of first light sources and the predetermined region of the light guide plate.

According to an embodiment of the technology, there is provided an electronic apparatus provided with a display unit, the display unit including a display section configured to display a plurality of perspective images and a light source device configured to emit light for displaying the plurality of perspective images toward the display section. The light source device includes: one or a plurality of first light sources each configured to emit first illumination light; and a light guide plate having a first end surface, a second end surface, and a plurality of scattering regions, and scattering the first illumination light in the plurality of scattering regions to emit the light to outside, the first end surface and the second end surface being opposed to each other, and the plurality of scattering regions being provided with a constant density and a uniform shape in a predetermined region between the first end surface and the second end surface. The one or the plurality of first light sources are arranged to face at least the first end surface, and an inclined section guiding the first illumination light to the predetermined region is provided between the one or the plurality of first light sources and the predetermined region of the light guide plate.

In the light source device, the display unit, and the electronic apparatus according to the respective embodiments of the present disclosure, the first illumination light from the first light source is scattered by the scattering regions and is emitted to the outside of the light guide plate. Therefore, it is possible to allow the light guide plate to have a function as a parallax barrier with respect to the first illumination light. In other words, equivalently, the light guide plate functions as a parallax barrier with the scattering regions as openings (slits). Therefore, it is possible to achieve three-dimensional display and multiple viewing.

Moreover, non-uniformity in luminance distribution of light emitted from the light guide plate (in-plane luminance distribution of the first illumination light) is improved by the inclined section provided between the first light source and the predetermined region of the light guide plate.

In the light source device, the display unit, and the electronic apparatus according to the respective embodiments of the present disclosure, the plurality of scattering regions scattering the first illumination light are provided on the light guide plate. Therefore, it is possible to allow the light guide plate to have a function as a parallax barrier equivalently, with respect to the first illumination light.

In addition, the inclined section guiding the first illumination light to the predetermined region is provided between the first light source and the predetermined region of the light guide plate. Therefore, it is possible to improve non-uniformity in in-plane luminance distribution of the first illumination light.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a sectional diagram illustrating a configuration example in Y direction of a display unit according to a first embodiment of the present disclosure.

FIG. 2 is a sectional diagram illustrating a configuration example in X direction of the display unit.

FIG. 3 is a plan view illustrating a configuration example of a light guide plate.

FIG. 4 is a plan view illustrating an example of a pixel structure of a display section.

FIG. 5 is a sectional diagram illustrating an example of an emission state of light beams in the case where only a first light source is turned on (put in a lighting state).

FIG. 6 is a plan view illustrating an example of an in-plane light-emission pattern in the case where only the first light source is turned on (put in the lighting state).

FIG. 7 is a sectional diagram illustrating an example of an emission state of light beams in the case where only a second light source is turned on (put in the lighting state).

FIG. 8 is a plan view illustrating an example of an in-plane light-emission pattern in the case where only the second light source is turned on (put in the lighting state).

FIG. 9 is a sectional diagram illustrating a configuration example in the Y direction of a display unit according to a comparative example.

FIG. 10 is a characteristic diagram illustrating an example of luminance distribution of a light-emission surface of a light guide plate in the display unit according to the comparative example.

FIG. 11 is an explanatory diagram of a structure of a first end section of the light guide plate on a side close to the first light source.

FIG. 12 is an explanatory diagram of a structure of a second end section of the light guide plate on a side opposed to the first light source.

FIG. 13 is a characteristic diagram illustrating angular distribution of a light beam entering the second end section of the light guide plate.

FIG. 14 is a characteristic diagram illustrating angular distribution of a light beam reflected by the second end section of the light guide plate.

FIG. 15 is a characteristic diagram illustrating an example of luminance distribution of a light-emission surface of the light guide plate in the case where an inclined section is provided on the first end section of the light guide plate.

FIG. 16 is a characteristic diagram illustrating an example of luminance distribution of a central part in the Y direction based on difference in structure of the first end section of the light guide plate.

FIG. 17 is a characteristic diagram illustrating an example of luminance distribution of a light-emission surface of the light guide plate in the case where a reflector is provided on the second end section of the light guide plate (α=0 deg).

FIG. 18 is a characteristic diagram illustrating an example of luminance distribution of the light-emission surface of the light guide plate in the case where the reflector is provided on the second end section of the light guide plate (α=7 deg).

FIG. 19 is a characteristic diagram illustrating an example of luminance distribution of the central part in the Y direction based on difference in structure of the second end section of the light guide plate.

FIG. 20 is a characteristic diagram illustrating an example of luminance distribution of the central part in the Y direction based on difference in structure of the first end section and the second end section of the light guide plate.

FIG. 21 is a sectional diagram illustrating a first modification of the structure of the first end section of the light guide plate.

FIG. 22 is a sectional diagram illustrating a second modification of the structure of the first end section of the light guide plate.

FIG. 23 is a sectional diagram illustrating a third modification of the structure of the first end section of the light guide plate.

FIG. 24 is a sectional diagram illustrating a first modification of the structure of the second end section of the light guide plate.

FIG. 25 is a sectional diagram illustrating a second modification of the structure of the second end section of the light guide plate.

FIG. 26 is a sectional diagram illustrating a third modification of the structure of the second end section of the light guide plate.

FIG. 27 is a sectional diagram illustrating a fourth modification of the structure of the second end section of the light guide plate.

FIG. 28 is a sectional diagram illustrating a configuration example of a display unit according to a second embodiment.

FIG. 29 is a sectional diagram illustrating a configuration example of a display unit according to a third embodiment.

FIG. 30 is a sectional diagram illustrating a configuration example of a display unit according to a fourth embodiment.

FIG. 31 is an appearance diagram illustrating an example of an electronic apparatus.

### DETAILED DESCRIPTION

Hereinafter, some embodiments of the disclosure will be described in detail with reference to drawings. Note that description will be given in the following order.

1. First Embodiment
Entire Configuration of Display Unit
Basic Operation of Display Unit
Detailed Description of Structure of End Sections of Light Guide Plate Modifications

2. Second Embodiment

3. Third Embodiment

4. Fourth Embodiment

5. Other Embodiments

### 1. First Embodiment

### Entire Configuration of Display Unit

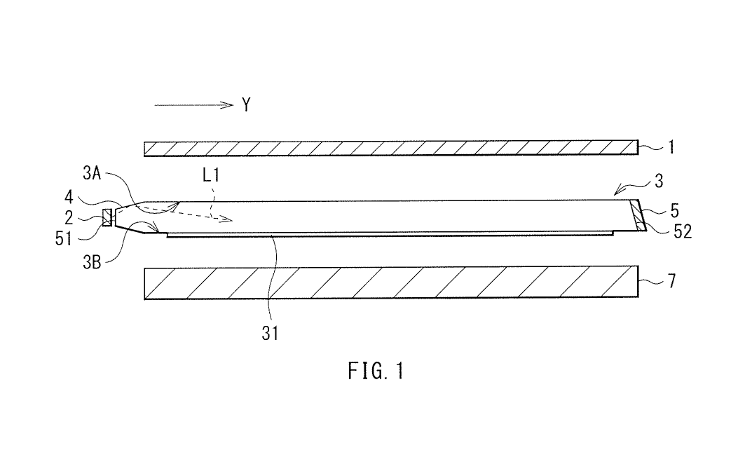

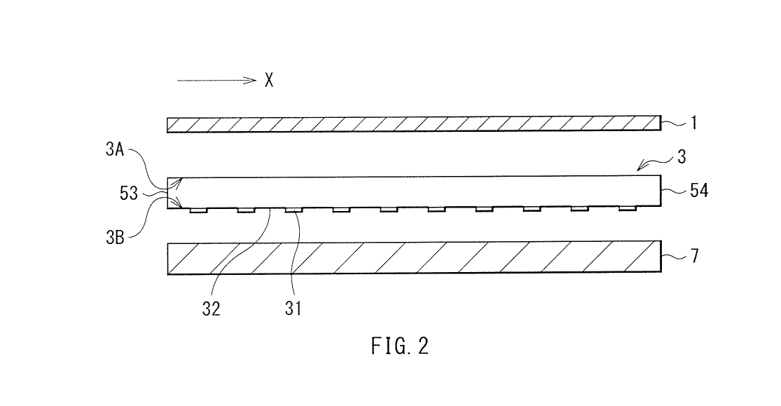

FIG. 1 and FIG. 2 illustrate a configuration example of a display unit according to a first embodiment of the disclosure. The display unit includes a display section 1 performing image display, and a light source device that is disposed on a back surface side of the display section 1 and emits light for the image display toward the display section 1. The light source device includes a first light source 2, a light guide plate 3, and a second light source 7. The light guide plate 3 has a first internal reflection surface 3A that is arranged so as to face the display section 1, and a second internal reflection surface 3B that is arranged so as to face the second light source 7. The light guide plate 3 also has a first end surface 51 and a second end surface 52 that are opposed to each other in Y direction (FIG. 1). Moreover, the light guide plate 3 has a third end surface 53 and a fourth end surface 54 that are opposed to each other in X direction (FIG. 2). Additionally, the display unit includes a control circuit for display section 1 that is necessary for display, and the like. However, the configurations thereof are similar to those of a typical control circuit for display and the like, and thus the description thereof will be omitted. In addition, although not illustrated, the light source device includes a control circuit performing ON (lighting)-OFF (non-lighting) control of the first light source 2 and the second light source 7.

Incidentally, in the first embodiment, a first direction (a vertical direction) in a display surface (an arrangement surface of pixels) of the display section 1 or in a plane parallel to the second internal reflection surface 3B of the light guide plate 3 is referred to as the Y direction (FIG. 1), and a second direction (a horizontal direction) orthogonal to the first direction is referred to as the X direction (FIG. 2).

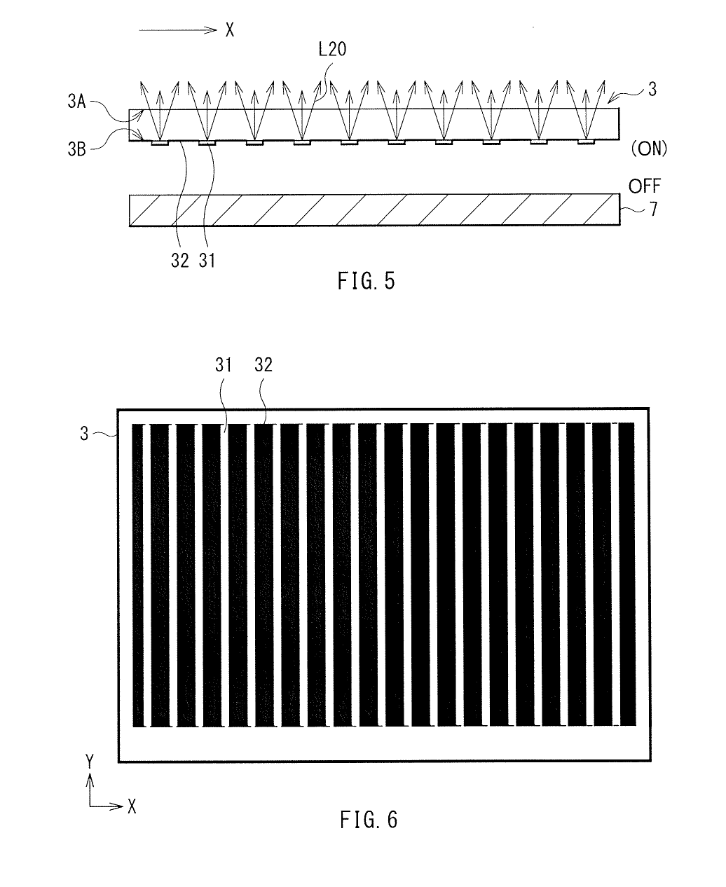

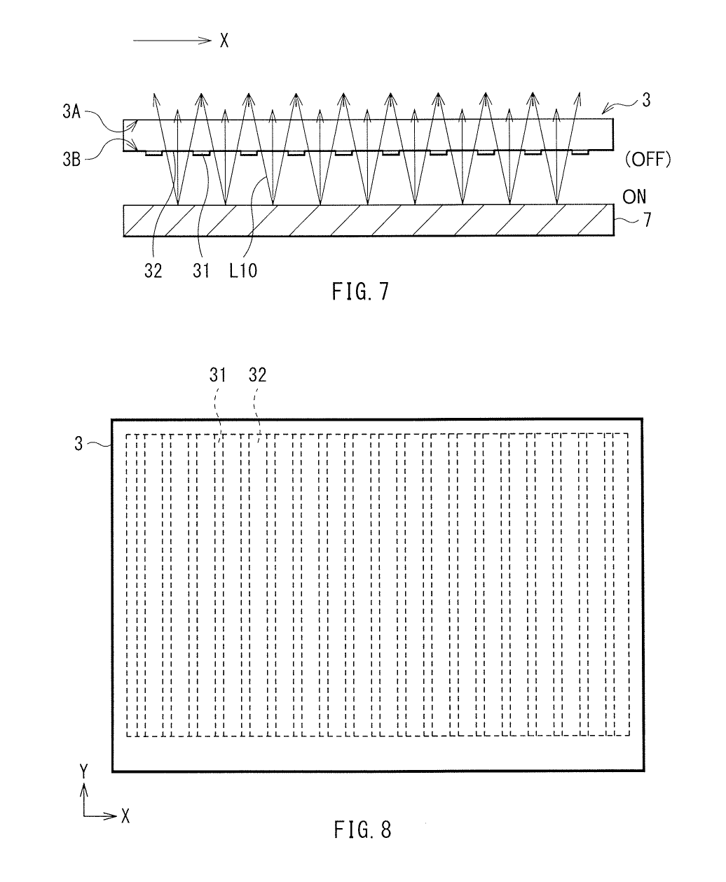

The display unit is capable of selectively switching over a display mode arbitrarily between a two-dimensional (2D) display mode over the entire screen and a three-dimensional (3D) display mode over the entire screen. The switching over between the two-dimensional display mode and the three-dimensional display mode is allowed to be performed through switching control of image data to be displayed on the display section 1 and ON-OFF switching control of the first light source 2 and the second light source 7. FIG. 5 schematically illustrates an emission state of light beams from the light source device in the case where only the first light source 2 is turned on (put in a lighting state), and this emission state corresponds to the three-dimensional display mode. FIG. 6 illustrates an example of an in-plane emission pattern of light emitted from the light guide plate 3 in the case where only the first light source 2 is turned on (put in the lighting state). FIG. 7 schematically illustrates an emission state of light beams from the light source device in the case where only the second light source 7 is turned on (put in the lighting state), and this emission state corresponds to the two-dimensional display mode. FIG. 8 illustrates an example of an in-plan emission pattern of light emitted from the light guide plate 3 in the case where only the second light source 7 is turned on (put in the lighting state).

The display section 1 is configured using a transmissive two-dimensional display panel such as a transmissive liquid crystal display panel. For example, as illustrated in FIG. 4, the display section 1 includes a plurality of pixels arranged in a matrix. Each of the plurality of pixels is configured of a red (R) sub-pixel 11R, a green (G) sub-pixel 11G, and a blue (B) sub-pixel 11B. The display section 1 modulates each color of light from the light source device from one pixel to another based on image data, to perform two-dimensional image display. A plurality of perspective images based on three-dimensional image data or an image based on two-dimensional image data is arbitrarily and selectively displayed on the display section 1 through switching over. Incidentally, for example, the three-dimensional image data is data containing a plurality of perspective images corresponding to a plurality of viewing angle directions in three-dimensional display. For example, in the case where binocular three-dimensional display is performed, the three-dimensional image data is data containing perspective images for right-eye display and for left-eye display. In the case where display is performed in the three-dimensional display mode, for example, a composite image including a plurality of stripe-shaped perspective images in one screen is created and displayed.

For example, the first light source 2 may be configured using a fluorescent lamp such as a cold cathode fluorescent lamp (CCFL), or light emitting diode (LED). The first light source 2 emits first illumination light L1 (FIG. 1) from a side surface direction toward the inside of the light guide plate 3. One or more first light sources 2 need to be provided on side surfaces of the light guide plate 3. In the first embodiment, the case where the first light source 2 is disposed so as to face the first end surface 51 of the light guide plate 3 is described as an example. The first light source 2 is ON (lighting)-OFF (non-lighting) controlled in response to switching over between the two-dimensional display mode and the three-dimensional display mode. Specifically, the first light source 2 is controlled to be in the lighting state when the display section 1 displays an image based on the three-dimensional image data (in the case of the three-dimensional display mode), and is controlled to be in the non-lighting state or the lighting state when the display section 1 displays an image based on the two-dimensional image data (in the case of the two-dimensional display mode).

The second light source 7 is disposed so as to face a side provided with the second internal reflection surface 3B of the light guide plate 3. The second light source 7 emits second illumination light L10 from a direction different from that of the first light source 2 toward the light guide plate 3. More specifically, the second light source 7 emits the second illumination light L10 from the outside (the back surface side of the light guide plate 3) toward the second internal reflection surface 3B (see FIG. 7). The second light source 7 is a planar light source. For example, the second light source 7 may have a configuration in which light emitters such as a CCFL and an LED are included, and a light diffuser panel diffusing light emitted from such light emitters is used. The second light source 7 is ON (lighting)-OFF (non lighting) controlled in response to switching over between the two-dimensional display mode and the three-dimensional display mode. Specifically, the second light source 7 is controlled to be in the non-lighting state in the case where the display section 1 displays an image based on the three-dimensional image data (in the case of the three-dimensional display), and is controlled to be in the lighting state in the case where the display section 1 displays an image based on the two-dimensional image data (in the case of the two-dimensional display mode).

The light guide plate 3 may be configured of a transparent plastic plate made of, for example, an acrylic resin. All of surfaces of the light guide plate 3 are transparent except for the second internal reflection surface 3B. In other words, the first internal reflection surface 3A and four end surfaces are transparent over the respective entire surfaces.

The first internal reflection surface 3A is subjected to mirror processing over the entire surface, and internally totally reflects the light beams entering the light guide plate 3 at an incident angle satisfying a total-reflection condition in the light guide plate 3, and emits part of the light beams that do not satisfy the total-reflection condition to the outside.

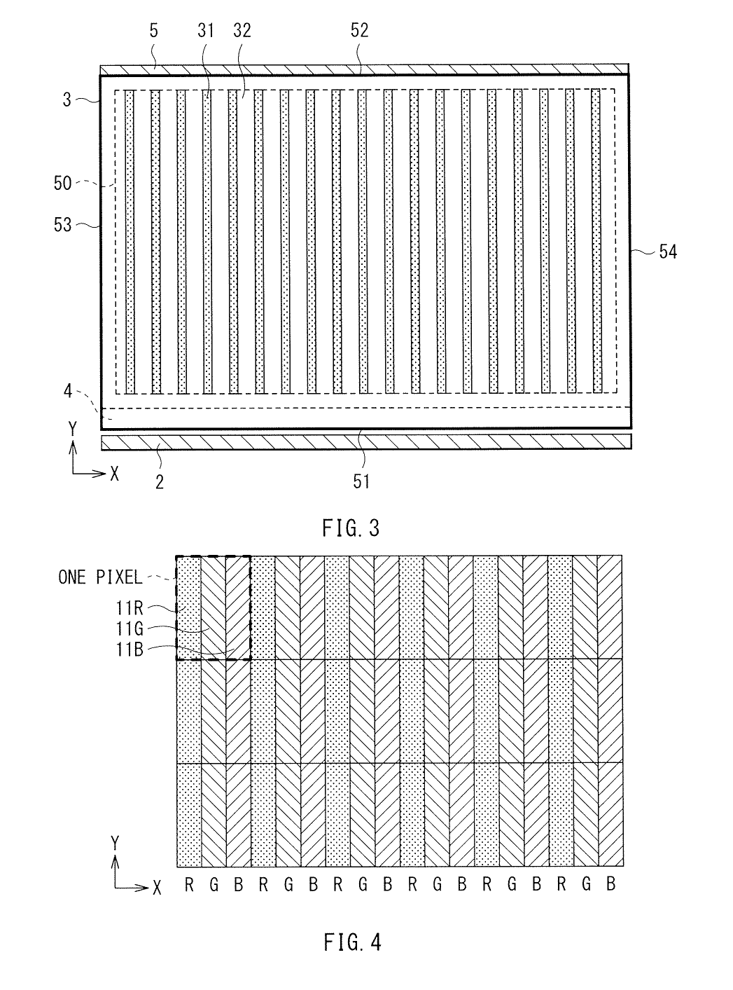

The second internal reflection surface 3B has scattering regions 31 and total reflection regions 32. For example, the scattering region 31 is configured of a scattering material printed on a surface of the light guide plate 3, or is subjected to laser processing, sandblast processing, or the like, thereby being added with light scattering property. In the second internal reflection surface 3B, in the case of the three-dimensional display mode, the scattering region 31 functions as an opening (a slit) as a parallax barrier with respect to the first illumination light L1 from the first light source 2, and the total reflection region 32 functions as a shielding section. In the second internal reflection surface 3B, the scattering regions 31 and the total reflection regions 32 are provided in a pattern corresponding to a parallax barrier. Specifically, the total reflection regions 32 are provided in a pattern corresponding to the shielding sections of the parallax barrier, and the scattering regions 31 are provided in a pattern corresponding to the openings of the parallax barrier. Note that the barrier pattern of the parallax barrier is not particularly limited, and various types of patterns such as a stripe pattern in which a large number of vertically-long slit-like openings are arranged side by side in the horizontal direction with the shielding sections in between may be used. FIG. 6 illustrates an example of an in-plane light-emission pattern of the light emitted from the light guide plate 3 (emitted light L20 from the first light source 2 (FIG. 5)) in the case where the plurality of scattering regions 31 each extending in the vertical direction are arranged in stripe shape, i.e., arranged side by side as illustrated in FIG. 3. As illustrated in FIG. 3, the plurality of scattering regions 31 are provided with a constant density and a certain shape in a predetermined region 50 between the first end surface 51 and the second end surface 52 of the light guide plate 3.

The first internal reflection surface 3A and the total reflection regions 32 of the second internal reflection surface 3B internally totally reflects a light beam that has entered the light guide plate 3 at the incident angle satisfying the total-reflection condition (internally totally reflects a light beam that has entered at an incident angle larger than a predetermined critical angle). Therefore, the first illumination light L1 from the first light source 2 that has entered the light guide plate 3 at an incident angle satisfying the total-reflection condition is guided to a side surface direction by internal total reflection between the first internal reflection surface 3A and the total reflection regions 32 of the second internal reflection surface 3B. As illustrated in FIG. 7, each of the total reflection regions 32 allows the second illumination light L10 from the second light source 7 to pass therethrough, and emits the second illumination light L10 toward the first internal reflection surface 3A as light beams that do not satisfy the total-reflection condition.

As illustrated in FIG. 1 and FIG. 5, each of the scattering regions 31 scatters and reflects the first illumination light L1 from the first light source 2, and emits at least part of the first illumination light L1, namely, light beams that do not satisfy the total-reflection condition, as emission light beams L20 toward the first internal reflection surface 3A.

An inclined section 4 (FIG. 1 and FIG. 3) is provided between the first light source 2 and the predetermined region 50 (FIG. 3) provided with the scattering regions 31 of the light guide plate 3. The inclined section 4 guides the first illumination light L1 from the first light source 2 to the predetermined region 50. In addition, a reflector 5 is provided on the second end surface 52. The reflector 5 guides the first illumination light L1 that has arrived at the second end surface 52, to the predetermined region 50. The inclined section 4 and the reflector 5 are provided to improve non-uniformity in luminance distribution of light emitted from the light guide plate 3 (luminance distribution, on a light emission surface (the second internal reflection surface 2B), of the first illumination light L1 that propagates through the light guide plate 3). Detail of non-uniformity in in-plane luminance distribution improved by the inclined section 4 and the reflector 5 will be described below.

(Basic Operation of Display Unit)

When the display unit performs display in the three-dimensional display mode, the display section 1 performs image display based on the three-dimensional image data, and the first light source 2 and the second light source 7 are ON (lighting)-OFF (non-lighting) controlled for three-dimensional display. Specifically, as illustrated in FIG. 5, the first light source 2 is controlled to be turned on (in the lighting state), and the second light source 7 is controlled to be turned off (in the non-lighting state). In this state, the first illumination light L1 from the first light source 2 is internally totally reflected repeatedly between the first internal reflection surface 3A and the total reflection regions 32 of the second internal reflection surface 3B in the light guide plate 3. As a result, the first illumination light L1 is guided from one side surface on a side provided with the first light source 2 to the other opposed side surface. On the other hand, part of the first illumination light L1 from the first light source 2 is scattered and reflected by the scattering regions 31 of the light guide plate 3 to pass through the first internal reflection surface 3A of the light guide plate 3, and is then emitted to the outside of the light guide plate 3. In this case, the light (the light L20 from the first light source 2 (FIG. 5)) is emitted from the light guide plate 3 in an in-plane emission pattern as illustrated in FIG. 6, for example. Therefore, the light guide plate 3 is allowed to have a function as a parallax barrier. Specifically, the light guide plate 3 equivalently functions as a parallax barrier with the scattering regions 31 as openings (slits) and the total reflection regions 32 as shielding sections, with respect to the first illumination light L1 from the first light source 2. Accordingly, three-dimensional display in parallax barrier system in which a parallax barrier is disposed on the back surface side of the display section 1 is performed equivalently.

On the other hand, when the display unit performs display in the two-dimensional display mode, the display section 1 performs image display based on the two-dimensional image data, and the first light source 2 and the second light source 7 are ON (lighting)-OFF (non-lighting) controlled for two-dimensional display. Specifically, as illustrated in FIG. 7, for example, the first light source 2 is controlled to be turned off (in the non-lighting state), and the second light source 7 is controlled to be turned on (in the lighting state). In this case, the second illumination light L10 from the second light source 7 passes through the total reflection regions 32 of the second internal reflection surface 3B. As a result, the second illumination light L10 is emitted from almost the entire surface of the first internal reflection surface 3A to the outside of the light guide plate 3 as light beams that do not satisfy the total-reflection condition. In this case, the light (the light emitted from the second light source 7) is emitted from the light guide plate 3 in an in-plane emission pattern as illustrated in FIG. 8, for example. In other words, the light guide plate 3 functions as a planar light source similar to a typical backlight. Accordingly, two-dimensional display in backlight system in which a typical backlight is disposed on the back surface side of the display section 1 is performed equivalently.

Note that, even if only the second light source 7 is turned on, the second illumination light L10 is emitted from almost the entire surface of the light guide plate 3. However, the first light source 2 may be turned on as necessary. As a result, for example, in the case where lighting of only the second light source 7 is not enough to eliminate difference in luminance distribution between a part corresponding to the scattering regions 31 and a part corresponding to the total reflection regions 32, appropriate adjustment of the lighting state of the first light source 2 (ON-OFF control or adjustment of an amount of the lighting) allows optimization of the luminance distribution over the entire surface. However, in the case of performing two-dimensional display, for example, when the display section 1 can perform sufficient luminance correction, it is only necessary to turn on the second light source 7.

(Detailed Description of Structure of End Sections of Light Guide Plate)

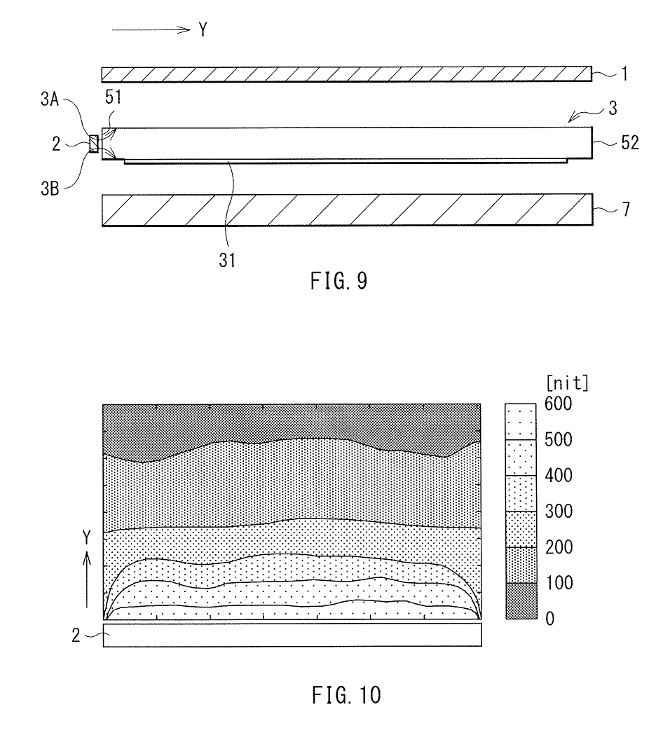

The inclined section 4 and the reflector 5 provided in the end sections of the light guide plate 3 are provided to vary angular distribution of the first illumination light L1 propagating through the inside of the light guide plate 3 and to improve non-uniformity of an amount of light beams entering the scattering regions 31. For example, in the case where the inclined section 4 and the reflector 5 are not provided in the end sections of the light guide plate 3 as with a display unit according to a comparative example illustrated in FIG. 9, the luminance distribution of light emitted from the light guide plate 3 is non-uniform as illustrated in FIG. 10, for example. As illustrated in FIG. 3, the plurality of scattering regions 31 with a constant density and a certain shape are provided in the predetermined region 50 between the first end surface 51 and the second end surface 52 of the light guide plate 3. In this case, for example, as illustrated in FIG. 10, the luminance may be higher as it is closer to the first light source 2 disposed in a first end section of the light guide plate 3, and the luminance is lower as it is closer to a second end section opposite to the first light source 2. If such non-uniformity in luminance distribution is present in the light emission surface, display quality in three-dimensional display is degraded. Hereinafter, the structure of the inclined section 4 and the reflector 5 that are to improve such non-uniformity in luminance distribution on the light emission surface will be described.

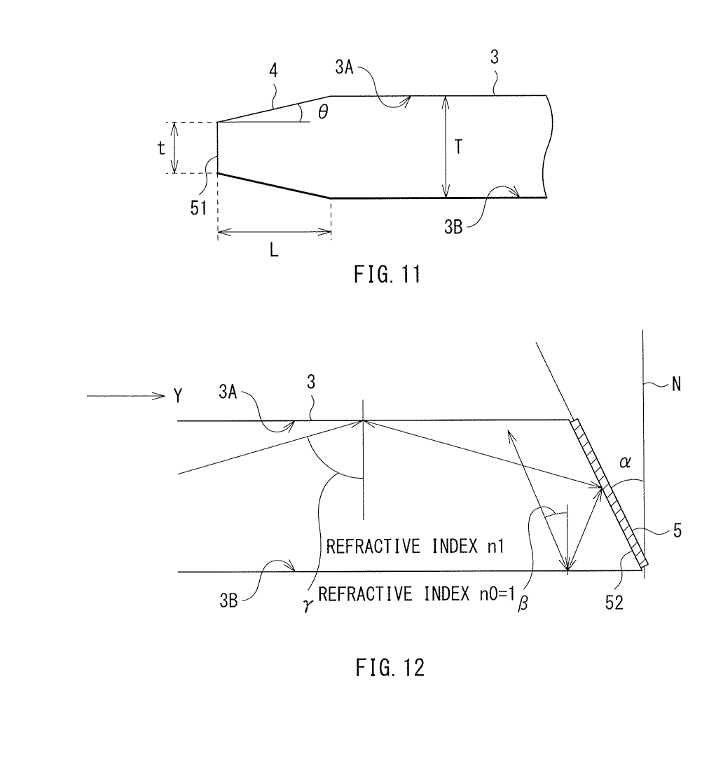

To improve the non-uniformity in luminance distribution as illustrated in FIG. 10, it is only necessary to make light that is collectively emitted from the first end section close to the first light source 2, partially reach the second end section opposite to the first end section. The structure of the inclined section 4 for improving the non-uniformity in luminance distribution is described with reference to FIG. 11. The inclined section 4 has a linear inclined cross-sectional surface. A thickness t of an incident end of the light guide plate 3, which receives the light from the first light source 2, may be desirably set to be equal to or larger than the size of the first light source 2 because the thickness t of the incident end relates to incident efficiency of light to the inside of the light guide plate 3.

When a thickness T of the light guide plate 3 and the thickness t of the incident end are determined, an inclined angle θ and an inclined length L of the inclined section 4 have a relationship represented by the following expression. The inclined angle θ is an inclined angle with respect to the first internal reflection surface 3A or the second internal reflection surface 3B of the light guide plate 3.

θ=arctan [(T−t)/2L]

When the inclined angle θ and the inclined length L are both large, effect of making the light that is collectively emitted from the first end section close to the first light source 2, partially reach the second end section on an opposed side is large. However, since the thickness T of the light guide plate 3 is determined from a design condition of stereoscopic viewing with naked eyes, and the thickness t of the incident end is substantially determined from the size of the first light source 2, the inclined angle θ and the inclined length L of the inclined section 4 are defined by above-described expression. In the case where the thickness T of the light guide plate 3 and the thickness t of the incident end are determined by the above-described expression, when the inclined length L of the inclined section 4 is increased, effect of concentrating the luminance distribution on the second end section side is more increased, and effect of uniformizing the luminance distribution is also increased. However, since the inclined angle θ is decreased along with the inclined length L being increased, the effect of uniformization is stopped at a certain level. Therefore, it is desirable to determine the shape of the inclined section 4 within a range smaller than a value of the inclined length L that is most effective in uniformization.

Next, the structure of the second end surface 52 and the reflector 5 for improving the non-uniformity in luminance distribution of light emitted from the light guide plate 3 is described with reference to FIG. 12. For example, the reflector 5 may be bonded to or arranged close to the second end surface 52. As illustrated in FIG. 12, it is desirable that the second end surface 52 and the reflector 5 are inclined at an inclined angle α with respect to a normal N to the first internal reflection surface 3A or the second internal reflection surface 3B of the light guide plate 3. In addition, it is desirable to satisfy the following expressions, where γ is an outward smallest propagation angle of light that has propagated through the light guide plate 3, β is a homeward smallest propagation angle of the light, n1 is a refractive index inside the light guide plate 3, and n0 is a refractive index (=1) outside the light guide plate 3.

β=γ−α

arcsin(n0/n1)≦β

The second end surface 52 and the reflector 5 are inclined in order to make the homeward smallest propagation angle β be decreased and to allow the light that has propagated through the inside of the light guide plate 3 to propagate through the light guide plate 3 again and then enter the scattering regions 31. When the homeward smallest propagation angle β is smaller than a critical angle of the light guide plate 3, the light is unintentionally emitted from the light guide plate 3, which results in luminance unevenness and degradation in light usage efficiency. Therefore, the luminance distribution is allowed to be adjusted by varying the inclined angle α within the range satisfying the above-described expressions.

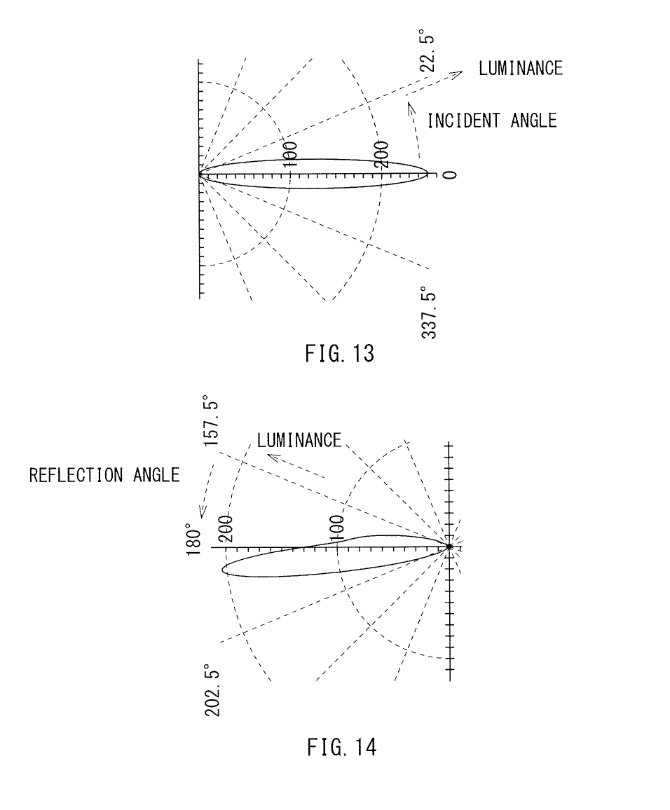

FIG. 13 illustrates an example of angular distribution of a light beam entering the second end section of the light guide plate 3, and FIG. 14 illustrates an example of angular distribution of a light beam reflected by the second end section of the light guide plate 3. As illustrated in FIG. 13, a large amount of the light that travels from the first end surface 51 provided with the first light source 2 and reaches the second end surface 52 faces in a direction (the Y direction) parallel to the surface of the light guide plate 3. Therefore, the light enters the scattering regions 31 with low probability, and is not easily emitted from the light guide plate 3. As illustrated in FIG. 12, the angular distribution direction of the light that has reached the second end surface 52 is allowed to be changed by the inclined reflection surface of the reflector 5 by causing the second end surface 52 and the reflector 5 to be inclined (see FIG. 14). In this way, changing the angular distribution direction of the light that has reached the second end surface 52 increases probability that the light enters the scattering region 31. This increases the luminance in proximity to the second end section.

(Specific Example of Improved Luminance Distribution on Light Emission Surface)

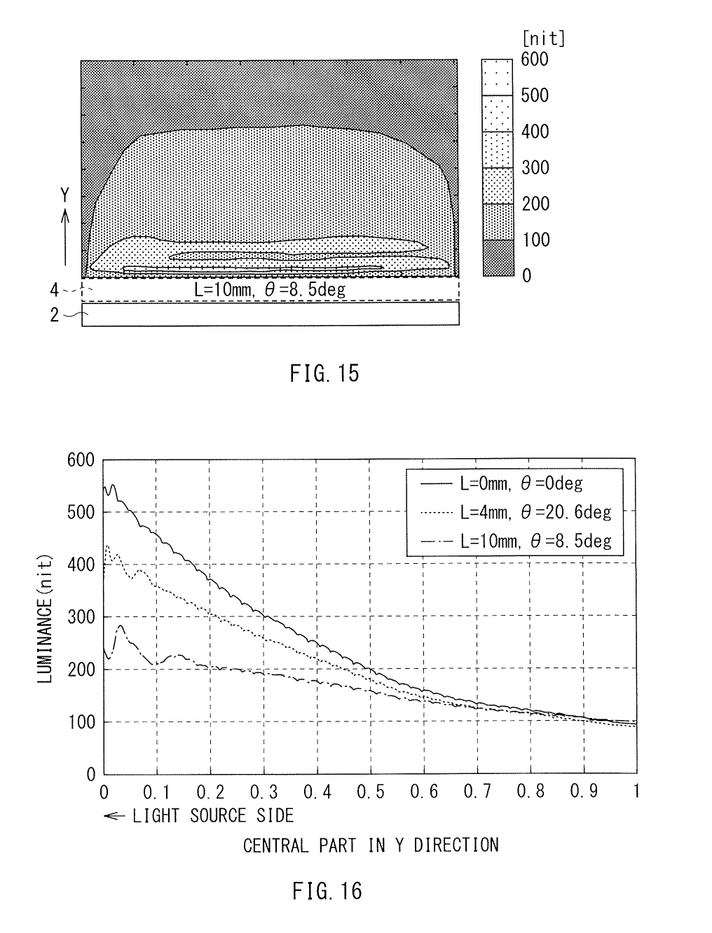

Hereinafter, a specific example of improved luminance distribution in the case where the inclined section 4 and the reflector 5 are not provided on the end sections of the light guide plate 3 (FIG. 9 and FIG. 10). FIG. 15 illustrates an example of luminance distribution of the light emission surface in the case where the inclined section 4 having the inclined length L of 10 millimeters (the inclined angle θ is 8.5 degrees) is provided on the first end section of the light guide plate 3. As illustrated in FIG. 15, non-uniformity in luminance distribution is improved as compared with the luminance distribution of the comparative example (FIG. 10). FIG. 16 illustrates an example of a luminance distribution of the central part in the Y direction based on difference in structure of the first end section of the light guide plate 3. FIG. 16 illustrates luminance distributions in each of the cases where the inclined length L of the inclined section 4 is 0 millimeter, 4 millimeters, and 10 millimeters (the inclined angle θ is 0 degrees, 20.6 degrees, and 8.5 degrees). It is found from FIG. 16 that increasing the inclined length L of the inclined section 4 suppresses luminance unevenness with high luminance in a region in the proximity to the first light source 2.

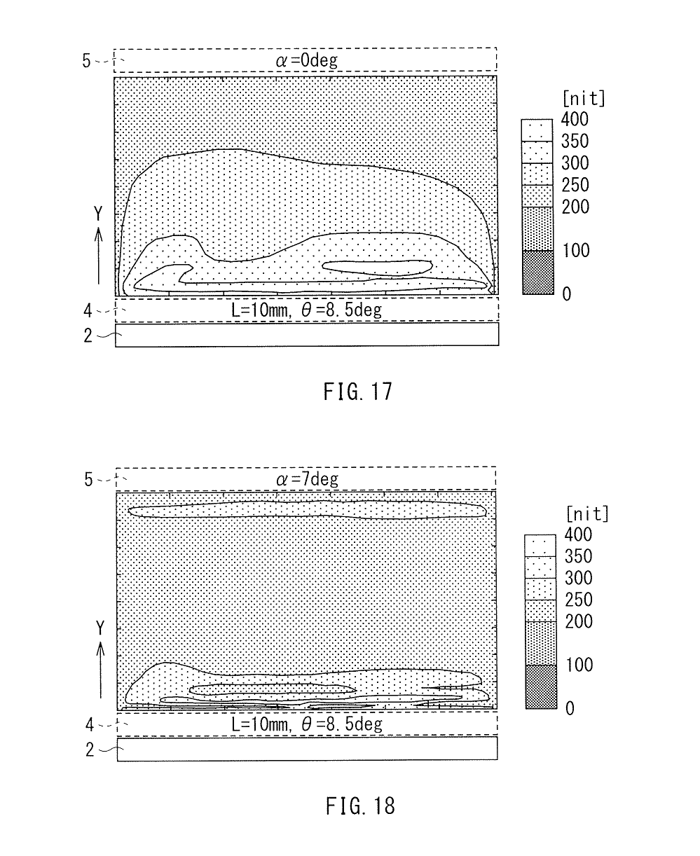

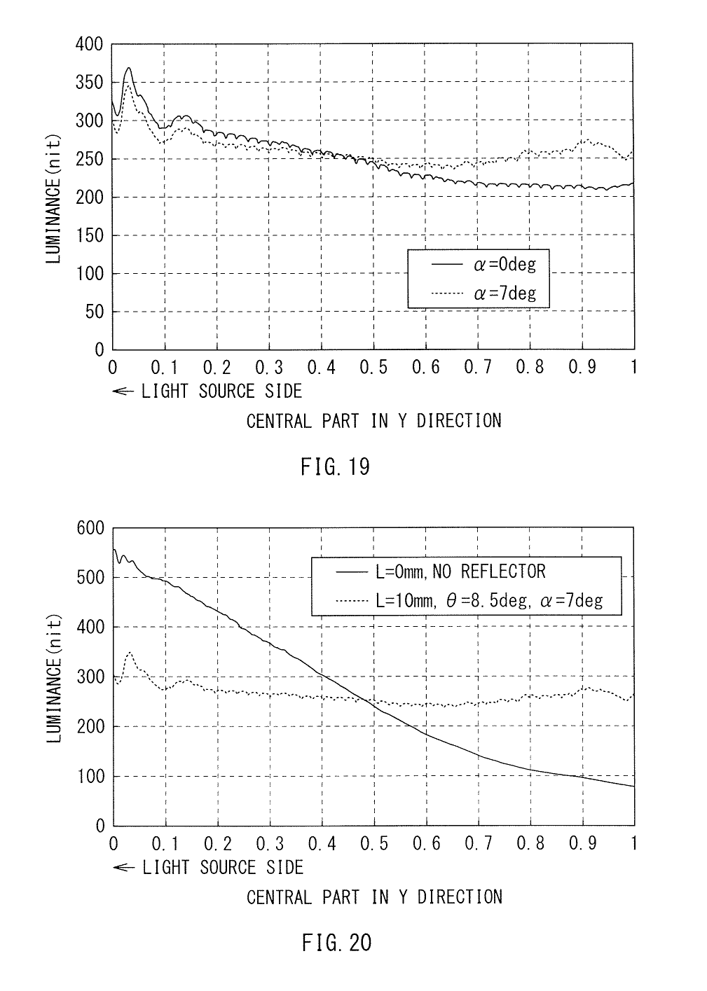

FIG. 17 illustrates an example of luminance distribution of the light emission surface in the case where the reflector 5 having the inclined angle α of 0 degrees is provided on the second end section of the light guide plate 3. FIG. 18 illustrates an example of luminance distribution of the light emission surface in the case where the reflector 5 having the inclined angle α of 7 degrees is provided on the second end section of the light guide plate 3. FIG. 19 illustrates an example of luminance distribution of the central part in the Y direction based on the difference in structure of the second end section of the light guide plate 3. FIG. 19 illustrates luminance distribution in each of the cases where the inclined angle α of the reflector 5 is 0 degrees and 7 degrees. It is found from the results of FIG. 17 to FIG. 19 that inclination of the reflector 5 leads to effects of improving luminance in the proximity to the second end section and more uniformizing the entire luminance distribution.

FIG. 20 illustrates an example of luminance distribution of the central part in the Y direction based on difference in structure between the first end section and the second end section of the light guide plate. FIG. 20 illustrates luminance distribution in the case where the inclined length L of the inclined section 4 is 10 millimeters (the inclined angle θ is 8.5 degrees) and the inclined angle α of the reflector 5 is 7 degrees, and luminance distribution in the case where the inclined length L of the inclined section 4 is 0 millimeter (the inclined angle θ is 0 degrees) and the reflector 5 is not provided. As apparent from FIG. 20, providing the inclined section 4 and the reflector 5 in the end sections of the light guide plate 3 significantly improves non-uniformity of the luminance distribution.

Next, Table 1 illustrates more specific numerical examples of the configuration of the end sections of the light guide plate 3. As the specific numerical examples, a screen size of the display section 1 and a number of perspectives of the three-dimensional display were specifically set, and desirable configuration parameters of the inclined section 4 and the reflector 5 were set. The non-uniformity of the luminance distribution was favorably improved when the configuration parameters were set to the numerical examples of Table 1.

TABLE 1

| Screen | Number of | Thickness T of Light | Thickness t of | Inclined Length | Inclined | Inclined |
|---|---|---|---|---|---|---|
| Size | Perspectives | Guide Plate | Incident End | L | Angle θ | Angle α |
| 24 inch | 6 | 3.0 mm | 1.6 mm | 4.0 mm | 9.9 deg | 8.0 deg |
| 24 inch | 6 | 4.0 mm | 2.5 mm | 5.0 mm | 8.5 deg | 10.0 deg |
| 32 inch | 6 | 6.0 mm | 3.0 mm | 10.0 mm | 8.5 deg | 7.0 deg |

According to the above-described numerical examples, the inclined angle θ of the inclined section 4 may be desirably equal to or larger than 5 degrees and equal to or smaller than 20 degrees. More desirably, the inclined angle θ may be equal to or larger than 8 degrees and equal to or smaller than 11 degrees. In addition, the inclined angle α of the reflector 5 may be desirably equal to or larger than 0 degrees and equal to or smaller than 15 degrees. More desirably, the inclined angle α may be equal to or larger than 6 degrees and equal to or smaller than 11 degrees.

(Modifications)

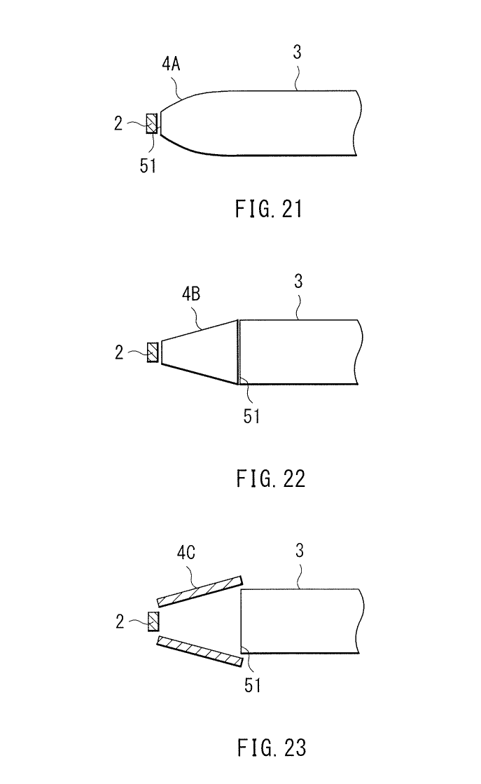

FIG. 21 to FIG. 23 illustrates modifications of the structure of the first end section of the light guide plate 3 (the end section on the side provided with the first light source 2). Even in the structure of the modifications described below, it is possible to obtain effect similar to the above-described improvement effect of the luminance distribution by the inclined section 4.

FIG. 21 illustrates a first modification of the first end section. The shape of the inclined section 4 is not limited to the shape having the linear cross-sectional surface as illustrated in FIG. 11. An inclined section 4A having a curved surface as with the first modification illustrated in FIG. 21 may be employed.

FIG. 22 illustrates a second modification of the first end section. FIG. 23 illustrates a third modification of the first end section. In the configuration examples in FIG. 11 and FIG. 21, the shape of the light guide plate 3 is processed to form the inclined section 4. As a result, the inclined section 4 is provided between the first end surface 51 and the predetermined region 50 (FIG. 3) provided with the scattering regions 31 of the light guide plate 3. On the other hand, in the second modification of FIG. 22, the light guide plate 3 itself is not provided with the inclined section 4, and a separate part from the light guide plate 3 is provided between the first end surface 51 and the first light source 2 to provide a similar inclined section 4B. In FIG. 22, the part configuring the inclined section 4B may be configured by closely disposing a material that has a refractive index same as or similar to that of the light guide plate 3, or may be configured by bonding a material having a refractive index similar to that of the light guide plate 3. In the third modification of FIG. 23, the light guide plate 3 itself is not provided with the inclined section 4, and a mirror reflection plate 4C is provided at a slanted angle between the first end surface 51 and the first light source 2 separately from the light guide plate 3. Therefore, the mirror reflection plate 4C has a function similar to that of the inclined section 4.

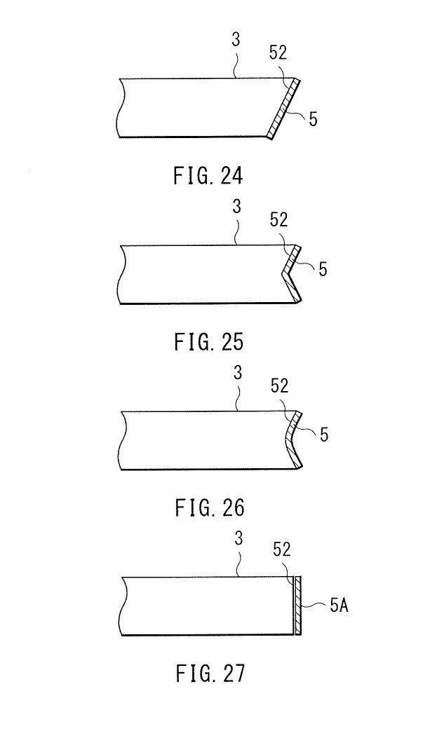

FIG. 24 to FIG. 27 each illustrate a modification of the structure of the second end section (the end section on the side opposite to the first light source 2) of the light guide plate 3. Even in the structure of the modifications described below, it is possible to obtain effect similar to the above-described improvement effect of the luminance distribution by the reflector 5.

FIG. 24 illustrates a first modification of the second end section. FIG. 25 illustrates a second modification of the second end section. FIG. 26 illustrates a third modification of the second end section. As illustrated in the modifications of FIG. 24 to FIG. 26, the shape of the second end surface 52 and the shape of the reflector 5 are not limited to a shape having a linear cross-sectional surface inclined toward the first end section side (see FIG. 12). The shape of the second end surface 52 and the shape of the reflector 5 may be a shape inclined toward a side opposite to the first end section as with the first modification of FIG. 24. In addition, the shape of the second end surface 52 and the shape of the reflector 5 may be a shape having a bending cross-sectional surface as with the second modification of FIG. 25. Moreover, the shape of the second end surface 52 and the shape of the reflector 5 may be a shape having a curved cross-sectional surface as with the third modification of FIG. 26. In any of the modifications of FIG. 24 to FIG. 26, for example, the reflector 5 is bonded to or arranged closely to the second end surface 52. Moreover, in any of the modifications, it is desirable to determine the shape within a range where light reflected by the reflector 5 has a reflection angle within the total reflection angle of the light guide plate 3 and the reflected light is not directly output from the light guide plate 3.

FIG. 27 illustrates a fourth modification of the second end section. In FIG. 27, a diffuse reflector 5A is provided on the second end surface 52. The diffuse reflector 5A diffuses reflected light within a range where the reflected light is within the total reflection angle of the light guide plate 3. As the diffuse reflector 5A, not a mirror reflector but a reflector having a diffuseness is bonded to the second end surface 52.

### 2. Second Embodiment

Next, a display unit according to a second embodiment is described. Note that like numerals are used to designate substantially like components of the display unit according to the first embodiment, and the description thereof is appropriately omitted.

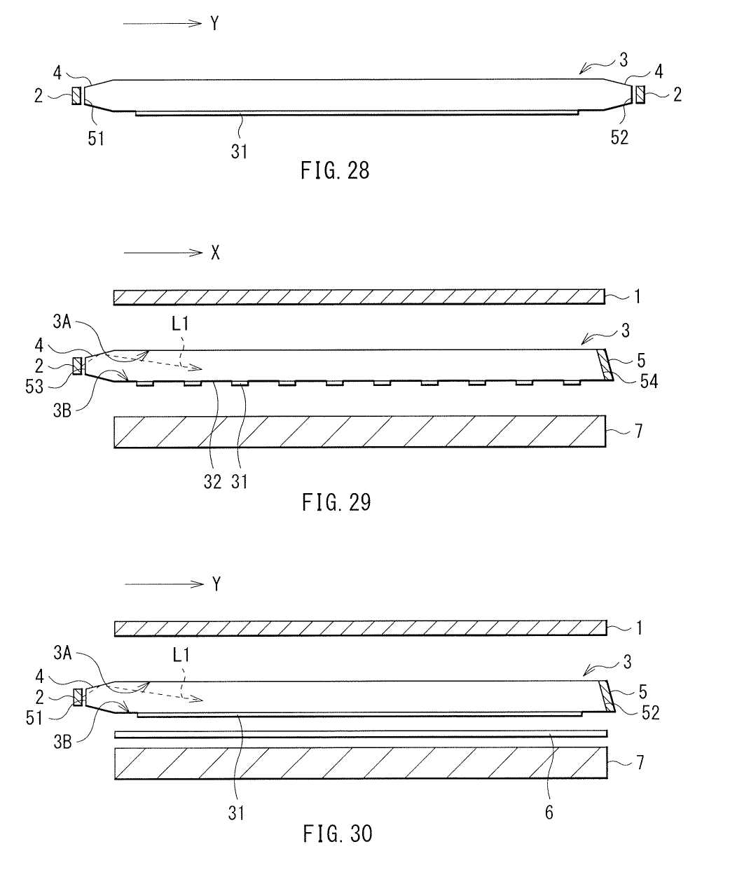

FIG. 28 illustrates a configuration example of the display unit according to the second embodiment of the present disclosure. Although one first light source 2 is provided in the first embodiment, two first light sources 2 may be provided as illustrated in FIG. 28. Specifically, one of the two first light sources 2 may be provided so as to face the first end surface 51, and the other may be provided so as to face the second end surface 52. The inclined section 4 needs to be provided between the predetermined region 50 and the first light source 2 that is arranged so as to face the first end surface 51 and between the predetermined region 50 and the first light source 2 that is arranged so as to face the second end surface 52.

### 3. Third Embodiment

Next, a display unit according to a third embodiment of the present disclosure is described. Note that like numerals are used to designate substantially like components of the display unit according to the first or second embodiment, and the description thereof is appropriately omitted.

Although the configuration example in which the first light sources 2 are arranged in the vertical direction (the Y direction) of the light guide plate 3 is described in the first and second embodiments, the first light source 2 may be arranged in a lateral direction (the X direction). FIG. 29 illustrates such a configuration example of a display unit. The first light source 2 is arranged so as to face the first end surface 51 of the light guide plate 3 in the configuration example of FIG. 1, whereas the first light source 2 is arranged so as to face the third end surface 53 in the configuration example of FIG. 29. Even in such a configuration, as with the above-described first embodiment, it is sufficient for the inclined section 4 to be provided on an end section (the third end section) on a side provided with the first light source 2. In addition, it is sufficient for the reflector 5 to be provided on the fourth end surface 54 opposed to the third end surface 53. As a result, as with the above-described first embodiment, it is possible to improve the non-uniformity in luminance distribution of light emitted from the light guide plate 3 (luminance distribution on the light emission surface (the second internal reflection surface 2B) of the first illumination light L1 propagating through the inside of the light guide plate 3).

Incidentally, the first light source 2 may be provided on both the third end surface 53 and the fourth end surface 54. In this case, as with the configuration example of FIG. 28, the inclined section 4 needs to be provided on two end sections (the third end section and the fourth end section) each provided with the first light source 2.

### 4. Fourth Embodiment

Next, a display unit according to a fourth embodiment of the present disclosure is described. Note that like numerals are used to designate substantially like components of the display unit according to any of the first to third embodiments, and the description thereof is appropriately omitted.

FIG. 30 illustrates a configuration example of the display unit according to the fourth embodiment. The display unit is configured by further providing a diffusion optical member 6 to the display unit of FIG. 1. The diffusion optical member 6 is disposed between the light guide plate 3 and the second light source 7.

The light guide plate 3 for three-dimensional display emits light toward the display section 1 side with use of, for example, a scattering reflection pattern, and thus the light is spread in a state close to Lambertian scattering. On the other hand, the second light source 7 that is a backlight for two-dimensional display collects light in a front direction with use of, for example, a prism sheet. Therefore, the light emitted from the second light source 7 is distributed in a narrow range as compared with the light emitted from the light guide plate 3. If the light distribution by the light guide plate 3 for three-dimensional display differs from the light distribution by the second light source 7 for two-dimensional display as described above, when both the light guide plate 3 (the first light source 2) and the second light source 7 emit light in two-dimensional display, or when display is switched between two-dimensional display and three-dimensional display, difference in light distribution is perceived, which results in inconvenience for a user.

Thus, the light distribution by the second light source 7 is allowed to be approached to the same or substantially the same as the light distribution of the light guide plate 3 for three-dimensional display so that the above-described disadvantage is dissolved. When the light distribution by the second light source 7 that is the backlight for two-dimensional display is expanded, the light distribution by the second light source 7 approaches the light distribution by the light guide plate 3 for three-dimensional display. Therefore, specifically, an optical member having effect of expanding light distribution, such as a diffuser plate, a diffuser sheet, and a prism sheet is disposed as the diffusion optical member 6 between the light guide plate 3 and the second light source 7 as illustrated in FIG. 30 to dissolve the above-described disadvantage. Alternatively, for example, the scattering reflection pattern same as that used in the light guide plate 3 is used in a backlight for two-dimensional display to dissolve the above-described disadvantage.

### 5. Other Embodiments

The technology in the present disclosure is not limited to the above-described embodiments, and various modifications may be made.

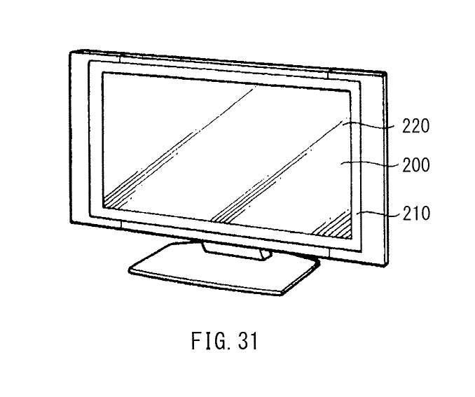

For example, the display unit according to any of the above-described embodiments is applicable to various electronic apparatuses having a display function. FIG. 31 illustrates an appearance configuration of a television as an example of such electronic apparatuses. The television is provided with a picture display screen section 200 including a front panel 210 and a filter glass 220.

In addition, in the above-described embodiments, the configuration example of the light guide plate 3 in which the scattering regions 31 and the total reflection regions 32 are provided on the second internal reflection surface 3B side has been described. However, the scattering regions 31 and the total reflection regions 32 may be provided on the first internal reflection surface 3A side.

Moreover, in the above-described embodiments, the case where the first illumination light L1 from the first light source 2 is used for three-dimensional display has been exemplified. However, instead of the three-dimensional display, so-called multi-view display allowing different images to be viewed depending on viewing directions may be performed.

Furthermore, for example, the technology may be configured as follows.

(1) A display unit including a display section configured to display a plurality of perspective images, and a light source device configured to emit light for displaying the plurality of perspective images toward the display section, the light source device including:

one or a plurality of first light sources each configured to emit first illumination light; and

a light guide plate having a first end surface, a second end surface, and a plurality of scattering regions, and scattering the first illumination light in the plurality of scattering regions to emit the light to outside, the first end surface and the second end surface being opposed to each other, and the plurality of scattering regions being provided with a constant density and a uniform shape in a predetermined region between the first end surface and the second end surface, wherein

the one or the plurality of first light sources are arranged to face at least the first end surface, and

an inclined section guiding the first illumination light to the predetermined region is provided between the one or the plurality of first light sources and the predetermined region of the light guide plate.

(2) The display unit according to (1), wherein

the light guide plate has a first internal reflection surface and a second internal reflection surface, and

an inclined angle of the inclined section with respect to the first internal reflection surface or the second internal reflection surface is about 5 degrees or more and about 20 degrees or less.

(3) The display unit according to (1) or (2), wherein the second end surface is provided with a reflector guiding the first illumination light that has reached the second end surface, to the predetermined region.

(4) The display unit according to (3), wherein

the light guide plate has a first internal reflection surface and a second internal reflection surface, and

the second end surface and the reflector are each inclined at an angle of about 0 degrees or more and about 15 degrees or less with respect to a normal to the first internal reflection surface or the second internal reflection surface.

(5) The display unit according to any one of (1) to (4), wherein the inclined section is provided between the first end surface and the predetermined region of the light guide plate.

(6) The display unit according to any one of (1) to (4), wherein the inclined section is provided between the first end surface and the first light source separately from the light guide plate.

(7) The display unit according to (1) or (2), wherein

two first light sources are provided, one of the two first light sources being arranged to face the first end surface, and the other being arranged to face the second end surface, and

the inclined section is provided between the predetermined region and the first light source that is arranged to face the first end surface, and between the predetermined region and the first light source that is arranged to face the second end surface.

(8) The display unit according to any one of (1) to (7), further including a second light source provided to face the light guide plate, the second light source being configured to emit second illumination light toward the light guide plate from a direction different from an emitting direction of the first light source.

(9) The display unit according to (8), wherein

the display section selectively switches display between the plurality of perspective images based on three-dimensional image data and an image based on two-dimensional image data, and

the second light source is controlled to be in a non-lighting state when the plurality of perspective images are displayed on the display section, and is controlled to be in a lighting state when the image based on the two-dimensional image data is displayed on the display section.

(10) The display unit according to (9), wherein the first light source is controlled to be in a lighting state when the plurality of perspective images are displayed on the display section, and is controlled to be in the non-lighting state or the lighting state when the image based on the two-dimensional image data is displayed on the display section.

(11) A light source device including:

one or a plurality of first light sources each configured to emit first illumination light; and

a light guide plate having a first end surface, a second end surface, and a plurality of scattering regions, and scattering the first illumination light in the plurality of scattering regions to emit light for displaying a plurality of perspective images to outside, the first end surface and the second end surface being opposed to each other, and the plurality of scattering regions being provided with a constant density and a uniform shape in a predetermined region between the first end surface and the second end surface, wherein

the one or the plurality of first light sources are arranged to face at least the first end surface, and

an inclined section guiding the first illumination light to the predetermined region is provided between the one or the plurality of first light sources and the predetermined region of the light guide plate.

(12) An electronic apparatus provided with a display unit, the display unit including a display section configured to display a plurality of perspective images and a light source device configured to emit light for displaying the plurality of perspective images toward the display section, the light source device including:

one or a plurality of first light sources each configured to emit first illumination light; and

a light guide plate having a first end surface, a second end surface, and a plurality of scattering regions, and scattering the first illumination light in the plurality of scattering regions to emit the light to outside, the first end surface and the second end surface being opposed to each other, and the plurality of scattering regions being provided with a constant density and a uniform shape in a predetermined region between the first end surface and the second end surface, wherein

the one or the plurality of first light sources are arranged to face at least the first end surface, and

an inclined section guiding the first illumination light to the predetermined region is provided between the one or the plurality of first light sources and the predetermined region of the light guide plate.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display unit including a display section configured to display a plurality of perspective images, and a light source device configured to emit light for displaying the plurality of perspective images toward the display section, the light source device comprising:
one or a plurality of first light sources each configured to emit first illumination light; and
a light guide plate having a first end surface, a second end surface, and a plurality of scattering regions, and scattering the first illumination light in the plurality of scattering regions to emit the light to outside, the first end surface and the second end surface being opposed to each other, and the plurality of scattering regions being provided with a constant density and a uniform shape in a predetermined region between the first end surface and the second end surface, wherein
the one or the plurality of first light sources are arranged to face at least the first end surface, and
an inclined section guiding the first illumination light to the predetermined region is provided between the one or the plurality of first light sources and the predetermined region of the light guide plate.

2. The display unit according to claim 1, wherein
the light guide plate has a first internal reflection surface and a second internal reflection surface, and
an inclined angle of the inclined section with respect to the first internal reflection surface or the second internal reflection surface is about 5 degrees or more and about 20 degrees or less.

3. The display unit according to claim 1, wherein the second end surface is provided with a reflector guiding the first illumination light that has reached the second end surface, to the predetermined region.

4. The display unit according to claim 3, wherein
the light guide plate has a first internal reflection surface and a second internal reflection surface, and
the second end surface and the reflector are each inclined at an angle of about 0 degrees or more and about 15 degrees or less with respect to a normal to the first internal reflection surface or the second internal reflection surface.

5. The display unit according to claim 1, wherein the inclined section is provided between the first end surface and the predetermined region of the light guide plate.

6. The display unit according to claim 1, wherein the inclined section is provided between the first end surface and the first light source separately from the light guide plate.

7. The display unit according to claim 1, wherein
two first light sources are provided, one of the two first light sources being arranged to face the first end surface, and the other being arranged to face the second end surface, and
the inclined section is provided between the predetermined region and the first light source that is arranged to face the first end surface, and between the predetermined region and the first light source that is arranged to face the second end surface.

8. The display unit according to claim 1, further comprising a second light source provided to face the light guide plate, the second light source being configured to emit second illumination light toward the light guide plate from a direction different from an emitting direction of the first light source.

9. The display unit according to claim 8, wherein
the display section selectively switches display between the plurality of perspective images based on three-dimensional image data and an image based on two-dimensional image data, and
the second light source is controlled to be in a non-lighting state when the plurality of perspective images are displayed on the display section, and is controlled to be in a lighting state when the image based on the two-dimensional image data is displayed on the display section.

10. The display unit according to claim 9, wherein the first light source is controlled to be in a lighting state when the plurality of perspective images are displayed on the display section, and is controlled to be in the non-lighting state or the lighting state when the image based on the two-dimensional image data is displayed on the display section.

11. A light source device comprising:
one or a plurality of first light sources each configured to emit first illumination light; and
a light guide plate having a first end surface, a second end surface, and a plurality of scattering regions, and scattering the first illumination light in the plurality of scattering regions to emit light for displaying a plurality of perspective images to outside, the first end surface and the second end surface being opposed to each other, and the plurality of scattering regions being provided with a constant density and a uniform shape in a predetermined region between the first end surface and the second end surface, wherein
the one or the plurality of first light sources are arranged to face at least the first end surface, and
an inclined section guiding the first illumination light to the predetermined region is provided between the one or the plurality of first light sources and the predetermined region of the light guide plate.

12. An electronic apparatus provided with a display unit, the display unit including a display section configured to display a plurality of perspective images and a light source device configured to emit light for displaying the plurality of perspective images toward the display section, the light source device comprising:
one or a plurality of first light sources each configured to emit first illumination light; and
a light guide plate having a first end surface, a second end surface, and a plurality of scattering regions, and scattering the first illumination light in the plurality of scattering regions to emit the light to outside, the first end surface and the second end surface being opposed to each other, and the plurality of scattering regions being provided with a constant density and a uniform shape in a predetermined region between the first end surface and the second end surface, wherein
the one or the plurality of first light sources are arranged to face at least the first end surface, and
an inclined section guiding the first illumination light to the predetermined region is provided between the one or the plurality of first light sources and the predetermined region of the light guide plate.
